(19) United States
(12) Patent Application Publication
(10) Pub. No.: US 2015/0257195 A1
(43) Pub. Date: Sep. 10, 2015

(54) LIMITING RADIO RESOURCE CONTROL CONNECTION REESTABLISHMENT

(71) Applicant: Nokia Technologies Oy, Espoo (FI)

(72) Inventors: Jussi-Pekka Koskinen, Oulu (FI); Jarkko Tuomo Koskela, Oulu (FI); Lars Dalsgaard, Oulu (FI); Ilkka Antero Keskitalo, Oulu (FI); Jorma Kaikkonen, Oulu (FI)

(21) Appl. No.: 14/433,470

(22) PCT Filed: Oct. 5, 2012
(86) PCT No.: PCT/US12/59112

§ 371 Date: Apr. 3, 2015

(51) Int. Cl. H04W 76/02

(52) U.S. Cl. CPC H04W 76/028; H04W 76/068

(57) ABSTRACT

Methods and apparatus, including computer program products, are provided for limiting connection setup after a failure. In one aspect there is provided a method. The method may include disconnecting, at a user equipment, a first radio resource control connection due to a failure; and determining, based on a state of at least one of the user equipment or an application included at the user equipment, whether to inhibit, after the failure, a connection setup by the user equipment. Related apparatus, systems, methods, and articles are also described.

The subject matter described herein relates to wireless communications.

### BACKGROUND

According to specifications, such as Third Generation Partnership Project (3GPP), TS 36.331, Evolved Universal Terrestrial Radio Access (E-UTRA), Radio Resource Control (RRC), Protocol specification, Release 11, user equipment shall initiate a radio resource control (RRC) connection reestablishment procedure after a failure, such as a radio link failure or a handover failure. For example, when the user equipment (UE) is in an RRC_CONNECTED state, the user equipment may lose, due to radio conditions, a connection to a cell being served by an access point. When this radio link failure (RLF) occurs, the user equipment promptly starts a cell selection procedure and then detects a suitable target cell. Moreover, the user equipment starts sending random access preambles to the network and/or access point, which may respond with a random access response. Next, the user equipment sends an RRCConnectionReestablishmentRequest message, and the network then responds by sending an RRCConnectionReestablishment message. In response, the user equipment then sends to the network an RRCConnectionReestablishmentComplete message, and the network responds by sending an RRCConnectionReconfiguration message to configure a data radio bearer. Next, the user equipment sends an RRCConnectionReconfigurationtComplete message to confirm that the data radio bearer is successfully completed. At the completion of the radio resource control signaling described above, the user equipment is in a connected state (referred to as a radio resource connected state or RRC_CONNECTED state).

### SUMMARY

Methods and apparatus, including computer program products, are provided for limiting reestablishment of radio resource control connections. In one aspect there is provided a method. The method may include disconnecting, at a user equipment, a first radio resource control connection due to a failure; and determining, based on a state of at least one of the user equipment or an application included at the user equipment, whether to inhibit, after the failure, a connection setup by the user equipment.

In some example embodiments, one of more variations may be made as well as described in the detailed description below and/or as described in the following features. The connection setup may be inhibited after the failure, when the state represents at least one of the following: a lack of active data requiring imminent transmission to a network; a presence of at least one of a delay tolerant traffic and a background traffic awaiting transmission; a long discontinuous receive cycle characterized by the lack of the active data; a timeout period expiry representing no use of at least one of the user equipment and the application; and a preference for power savings at the user equipment. When the state represents the active data requiring imminent transmission to the network, the connection setup may proceed by at least one of a reestablishing or an establishing of a second radio resource control connection. The connection setup may comprise at least one of a connection reestablishment procedure and a connection establishment procedure. There may be a selection between the connection reestablishment procedure and the connection establishment procedure based on at least one of an expiration of a timer and a predetermined configuration defining the selecting. The expiration of the timer may be configured by at least one of an access node, a predetermined value, or another timer operating at the user equipment. The user equipment may receive information configuring the inhibition of the connection setup. The failure may comprise at least one of a radio link failure and a handover failure.

The above-noted aspects and features may be implemented in systems, apparatus, methods, and/or articles depending on the desired configuration. The details of one or more variations of the subject matter described herein are set forth in the accompanying drawings and the description below. Features and advantages of the subject matter described herein will be apparent from the description and drawings, and from the claims.

### DESCRIPTION OF DRAWINGS

In the drawings,

FIG. 1 depicts an example of a system, in accordance with some example embodiments;

FIG. 2 depicts an example of a process for inhibiting RRC connection reestablishment, in accordance with some example embodiments;

FIG. 3 depicts another example of a process for inhibiting radio resource control connection reestablishment, in accordance with some example embodiments;

FIG. 4 depicts an example of an access point, in accordance with some example embodiments; and

FIG. 5 depicts an example of a radio, in accordance with some example embodiments.

Like labels are used to refer to same or similar items in the drawings.

### DETAILED DESCRIPTION

In some example embodiments, the subject matter disclosed herein relates to inhibiting the radio resource control connection reestablishment process after a failure, such as a radio link failure or a handover failure. For example, the user equipment may inhibit reestablishment of the resource control connection after the failure, when an application (also referred to herein as a service) at the user equipment does not have a need for the reestablishment of the radio resource control connection. The user equipment and/or application may not have this reestablishment need, when there is no active data transfer to the network (e.g., when the user equipment is only running delay tolerant applications) and/or when the user equipment has transmitted a power preference indication (PPI) preferring a configuration that is primarily optimized for power saving.

In some example embodiments in which there is no active data transfer taking place after the failure, the user equipment may be in one or more of the following states: a long discontinuous receive cycle (DRX) which may be characterized by a lack of data activity causing a triggering of an inactivity timer or a short DRX cycle; a lack of data transmission or data receipt at the user equipment over a certain time period; a lack of use of the user equipment and/or application(s) therein (e.g., the user equipment may be in a user's pocket, briefcase, nightstand, and the like). When the user equipment inhibits reestablishment of the resource control connection after the failure due to lack of need (e.g., no active data transfer imminently needed), this inhibition may, in some implementations, save power at the user equipment and/or reduce the RRC signaling between the user equipment and the network.

In some example embodiments, the inhibition of the reestablishment of the resource control connection may be allowed to proceed, when a need arises for the reestablishment of the radio resource control connection. The need may arise due to, for example, data arriving for the uplink (e.g., mobile originated traffic activation) or the downlink (e.g., mobile terminated traffic connection activation). After the radio link failure or the handover failure for example, the user equipment may allow the radio resource control connection reestablishment process to proceed, rather than inhibited, when the user equipment (or an application therein) has an active data transfer, although the radio resource control connection reestablishment process may also be allowed to proceed after the expiry of a certain time period after the failure and/or inhibition (e.g., after 1 minute, 2 minutes, 3 minutes, 4 minutes, 5 minutes, and other time period).

Before providing additional examples, the following provides an example of a system framework in which some of the example embodiments described herein may be implemented.

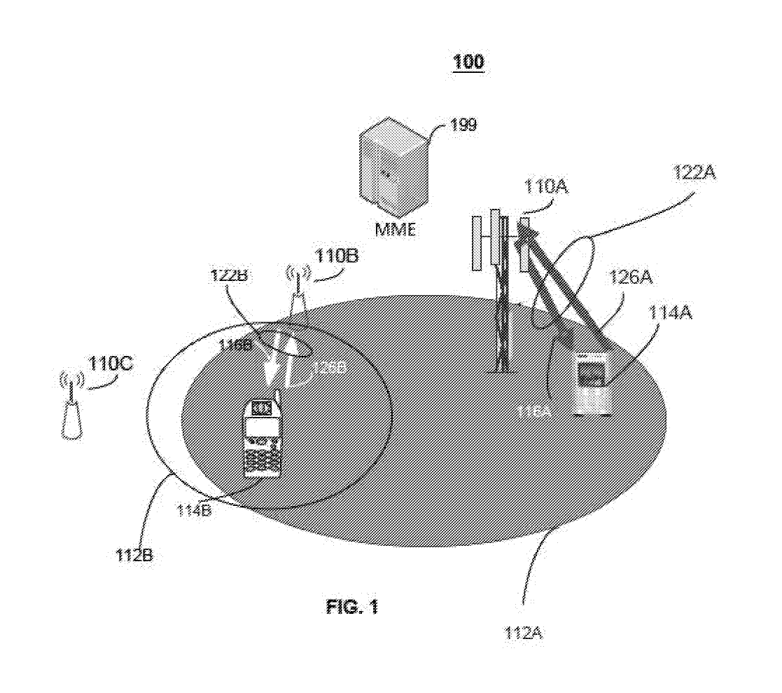

FIG. 1 depicts a system 100 according to some example embodiments. System 100 may include one or more user equipment, such as user equipment 114A-B, one or more access points, such as base stations 110A-C. In some example embodiments, base station 110A may serve a cell, such as macrocell 112A, and base stations 110A-B may serve a small cell, such as a picocell or a femtocell 112B, although base station 110B may serve other types of cells as well. Moreover, base stations may have wired and/or wireless backhaul links to other network nodes, such as a mobility management entity 199, other base stations, a radio network controller, a core network, a serving gateway, and the like.

In some example embodiments, user equipment 114A-B may be implemented as a user equipment and/or a stationary device. The user equipment 114A-B are often referred to as, for example, mobile stations, mobile units, subscriber stations, wireless terminals, tablets, smart phones, or the like. A user equipment may be implemented as, for example, a wireless handheld device, a wireless plug-in accessory, or the like. In some example embodiments, the user equipment may include one or more processors, one or more computer-readable storage medium (e.g., memory, storage, and the like), one or more radio access components (e.g., a modem, a transceiver, and the like), and/or a user interface. The computer readable medium may include code which when executed by a processor provides one or more applications.

In some example embodiments, the user equipment 114A-B may be implemented as multi-mode user devices configured to operate using a plurality of radio access technologies, although a single-mode device may be used as well. For example, user equipment 114A-B may be configured to operate using a plurality of radio access technologies including one or more of the following: Long Term Evolution (LTE), wireless local area network (WLAN) technology, such as 802.11 WiFi and the like, Bluetooth, Bluetooth low energy (BT-LE), near field communications (NFC), and any other radio access technologies. Moreover, the user equipment 114A-B may be configured to have established connections to access points using a plurality of the radio access technologies.

The base stations 110A-C may, in some example embodiments, be implemented as an evolved Node B (eNB) type base station, although other types of radio access points may be implemented as well. When the evolved Node B (eNB) type base station is used, the base stations, such as base stations 110A-B, may be configured in accordance with standards, including the Long Term Evolution (LTE) standards, such as 3GPP TS 36.201, Evolved Universal Terrestrial Radio Access (E-UTRA); Long Term Evolution (LTE) physical layer; General description, 3GPP TS 36.211, Evolved Universal Terrestrial Radio Access (E-UTRA); Physical channels and modulation, 3GPP TS 36.212, Evolved Universal Terrestrial Radio Access (E-UTRA); Multiplexing and channel coding, 3GPP TS 36.213, Evolved Universal Terrestrial Radio Access (E-UTRA); Physical layer procedures, 3GPP TS 36.214, Evolved Universal Terrestrial Radio Access (E-UTRA); Physical layer—Measurements, and any subsequent additions or revisions to these and other 3GPP series of standards (collectively referred to as LTE standards). The base stations may also be configured to serve cells using a WLAN technology, such as WiFi (e.g., the IEEE 802.11 series of standards), as well as any other radio access technology capable of serving a cell.

In some example embodiments, system 100 may include access links, such as links 122A-B. The access links 122A may include a downlink 116A for transmitting to the user equipment 114A and an uplink 126A for transmitting from user equipment 114A to the base station 110A. The downlink 116A may comprise a modulated radio frequency carrying information, such as user data, radio resource control (RRC) messages, location information, and the like, to the user equipment 114A, and the uplink 126A may comprise a modulated radio frequency carrying information, such as user data, RRC messages, location information, measurement reports associated with handovers, and the like, from the user equipment 114A to base station 110A. Access links 122B may include downlink 116B for transmitting from the base station 110B to user equipment 114B, and uplink 126B for transmitting from user equipment 114B to the base station 110B.

Although FIG. 1 depicts access links between certain user equipment and certain base stations, the user equipment and base stations may have additional links to other devices as well.

The downlink 116A and uplinks 126A may, in some example embodiments, each represent a radio frequency (RF) signal. The RF signal may, as noted above, carry data, such as voice, video, images, Internet Protocol (IP) packets, control information, and any other type of information and/or messages. For example, when LTE is used, the RF signal may use OFDMA. OFDMA is a multi-user version of orthogonal frequency division multiplexing (OFDM). In OFDMA, multiple access is achieved by assigning, to individual users, groups of subcarriers (also referred to as subchannels or tones). The subcarriers are modulated using BPSK (binary phase shift keying), QPSK (quadrature phase shift keying), or QAM (quadrature amplitude modulation), and carry symbols (also referred to as OFDMA symbols) including data coded using a forward error-correction code. The subject matter described herein is not limited to application to OFDMA systems, LTE, LTE-Advanced, or to the noted standards, specifications, and/or technologies. Furthermore, the downlink 116B and uplink 126B may be configured using standards and/or technologies similar to those noted with respect to downlink 116A and uplink 126A, although downlink 116B and uplink 126B may use different standards or technologies as well, such as WiFi, WiBro, BT-LE, and/or another other wireless technology. In addition, each access link may be unidirectional or bidirectional.

Although FIG. 1 depicts a specific quantity and configuration of base stations, cells, and user equipment, other quantities and configurations may be implemented as well.

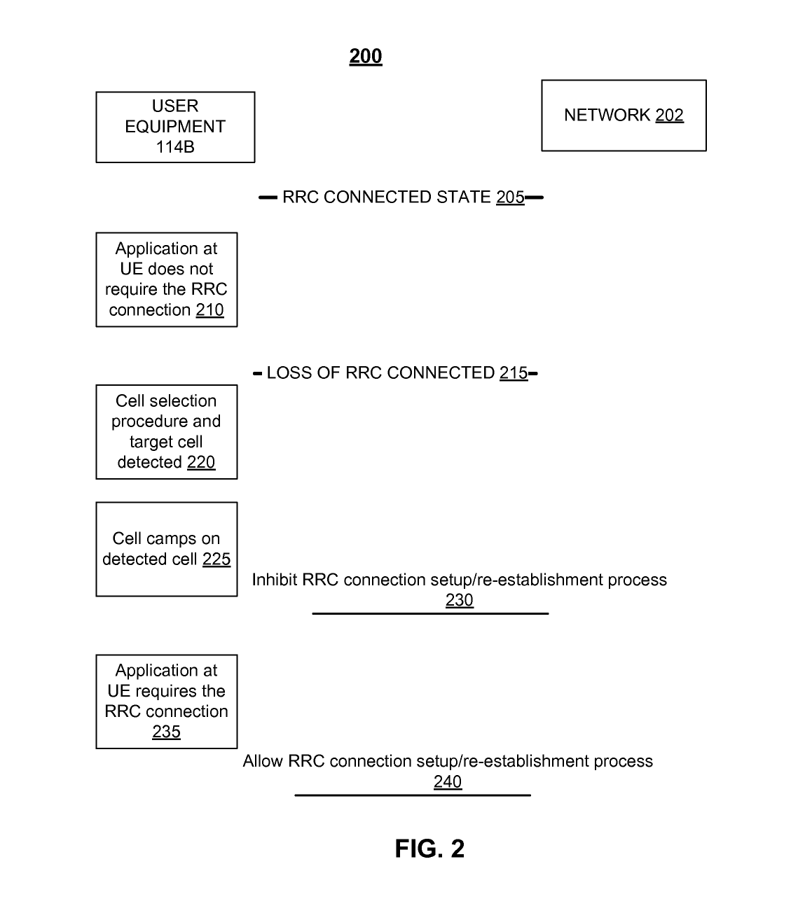

FIG. 2 depicts, in accordance with some example embodiments, a process 200 in which the reestablishment of the RRC connection is inhibited after a failure, such as a radio link failure or a handover failure, rather than reestablish the RRC connection.

At 205, user equipment 114B may, in some example embodiments, be in an RRC connected state (RRC_CONNECTED) with the network 202 (or a node therein, such as eNB base station 110B.

At 210, the user equipment 114B may, in some example embodiments, include at least one application (which may also be referred to as a service) in operation, but this running application may not, at a given time, need the RRC connection for active data traffic to (or from) the network, or the application may have only delay tolerant (and/or infrequent background) traffic for transmission to (or from) the network. And, in some example embodiments, the user equipment's radio frequency modem may be made aware of the absence of active traffic and the existence of only delay tolerant/background traffic. For example, the user equipment may be in a user's pocket or otherwise unattended and, in this example, the application operating at the user equipment may not have an immediate need for active data transmission to the network 202, and thus no immediate need for a RRC control connection reestablishment after the failure.

At 215, user equipment 114B may, in some example embodiments, lose the connection to the serving cell due to, for example, a failure caused by radio conditions, such as a radio link failure, a hand over failure, and the like. For example, the user equipment 114B may measure a poor quality downlink from base station 110B, in which case the link serving the cell 112B would fail.

At 220, user equipment 114B may, in some example embodiments, start a cell selection procedure and detect a suitable cell in order to identify a target cell after the failure. For example, user equipment 114B may determine that base station 110A is a target cell 112A to which it can couple, although user equipment 114B may also couple to any other base station and cell as well. For example, user equipment 114A may couple to the same cell serving user equipment 114A before the cell selection procedure.

At 225, user equipment 114B may, in some example embodiments, camp on the cell detected at 220. For example, equipment 114B may camp on target cell 112A served by base station 110A, although it may camp on other cells as well.

However, if the user equipment or one or more applications at the user equipment do not have a need for RRC connection reestablishment due to for example an inactive user equipment, delay tolerant traffic, no active data traffic, and the like, the user equipment may camp on the cell detected at 220, while inhibiting, after the failure, the reestablishment of the RRC connection. This inhibition may continue until, for example, there is a need for active data transmission.

In some example embodiments, user equipment 114B may, at 230, inhibit connection reestablishment, such as the RRC reestablishment, to network 202. For example, the user equipment 114B may camp on target cell 112A and inhibit the reestablishment of the RRC connection to base station 110A. The need may arise due to, for example, data arriving for the uplink (e.g., mobile originated traffic activation) or the downlink (e.g., mobile terminated traffic connection activation).

When there is need, at 235, for connection reestablishment, such as RRC connection reestablishment, initiation of the RRC connection process to the network 202 may be allowed, in accordance with some example embodiments. For example, user equipment 114B may allow, at 240, initiation of the RRC connection reestablishment process to the network 202 including base station 110A.

In some example embodiments, process 200 may result in a situation in which network 202 may not be aware of the location of user equipment 114B on a cell level, but instead network 202 may be aware of the user equipment on a tracking/location/routing area level after the radio link failure while the user equipment is camped on the cell. To address this situation, network 202 may page the user equipment 114B when user equipment 114B does not react to a Physical Downlink Control Channel (PDCCH) order or a scheduling in a last cell. Moreover, network 202 may page the user equipment 114B after a certain time (e.g., the time after which the user equipment 114B is allowed to not perform RRC connection reestablishment). From the perspective of user equipment 114B, this may mean that user equipment 114B would have to listen to paging messages instead of direct resource allocations on the PDCCH.

In some example embodiments, a user equipment's behavior with respect to the disclosed inhibition of RRC connection reestablishment may be defined by a standard. For example, a standard may define whether this inhibition of RRC connection reestablishment behavior can be used at the user equipment, the process for performing this inhibition, subsequent allowance of the RRC connection reestablishment, and the like. Additionally, a standard may define monitoring rules after inhibition of RRC connection reestablishment is invoked (e.g., whether a user equipment listens to paging after a cell change, whether the user equipment listens to a cell radio network temporary identifier (C-RNTI) after a time but a cell change has not occurred, and/or whether the user equipment listens to both C-RNTI and paging).

In some example embodiments, the network may send a message to the user equipment, and this message may indicate whether the user equipment can be configured to inhibit an RRC connection reestablishment as disclosed herein. This message may also indicate whether the user equipment can be configured to subsequently allow the RRC connection reestablishment. In some example embodiments, the network (e.g., an eNB base station or any other node in the network) may configure via signaling the user equipment to perform the inhibition and allowance of the RRC connection reestablishment. In some example embodiments, the inhibition and allowance of the RRC connection reestablishment at the user equipment may be configured as an autonomous behavior, enabling the user equipment to autonomously release the RRC connection when a failure occurs without trying to reestablish the RRC connection until the RRC connection is actually needed by the user equipment (or at least one of the applications therein).

In some example embodiments, after a failure and RRC connection reestablishment inhibition, the network may not know, as noted above, the detailed cell level location of the user equipment. When this is the case, the network may consider the user equipment to still be in the cell in which it was last scheduled by the network and thus the network may try to reach the user equipment at that last location by sending a request (e.g., PDCCH scheduling, a PDCCH order, and the like). As the user equipment may not reply to this request from the network (unless it is actually in the last scheduled cell), the network may page the user equipment in the local area in order to reach the user equipment. A delay in downlink establishment may also be managed by simultaneously scheduling the user equipment in the last cell and paging the user equipment, so that the user equipment can answer to either the scheduling if the cell has not changed or the page.

In some example embodiments, when determining whether to reestablish the RRC connection after a failure, the user equipment may consider one or more of the following factors: no application at the user equipment has connection needs within a certain period of time (e.g., no active data to send to, or expected from, the network in the near term); the user equipment is not actively being used (e.g., the user equipment is in a pocket, brief case, or otherwise unattended); no active data transmission received from the application for a given time; a screen at the user equipment is dim or off; a preference for power savings is indicated by the user equipment via a PPI; a motion sensor or other device indicates a user equipment which is idle, unattended, or the like. In some example embodiments, the user equipment or a radio frequency modem therein may determine, or be made aware of, these one or more factors. Moreover, in the case of a smart phone, an application may generate background traffic, which may be delay tolerant or infrequent (e.g., can be of the order of several tens of seconds or even longer), in which case the application does not require immediate access to a radio bearer for transmission. Moreover, the radio frequency modem at the user equipment may receive information representative of the type of running application at the user equipment, the nature of the traffic generation (e.g., infrequent, background, or active), the periodicity of the data transfer, or other similar information when making the decisions about whether RRC connection reestablishment should be inhibited after a failure, such as a radio link failure or a handover failure.

In some example embodiments, the inhibition of the RRC connection reestablishment after a failure, such as a radio link failure or a handover failure, may be configured in a variety of ways. For example, the RRC connection reestablishment procedure may be performed in a connected state (e.g., RRC_CONNECTED state) or in an idle state (e.g., an RRC_IDLE state). In either case, a process may be specified to be used when the user equipment has determined that it should perform the RRC connection reestablishment after a failure and the inhibition has been invoked. In addition, the decision of which of the alternatives to use may be based on a time signaled by the network. This network signaled time may represent how long the corresponding context for a RRC connection is to be retained by the network to facilitate the subsequent RRC reestablishment procedure. Alternatively, or additionally, the time may be configured in accordance with a timer representative of how long the context for the RRC connection is valid after a failure or after a prior (or last) data transmission. For example, a T311 timer may be used to determine whether, after a radio link failure, the context for the RRC connection is valid and can thus be used for the RRC reestablishment procedure. In this example, the T311 timer may be configured to continue to run even after the user equipment selects a suitable cell

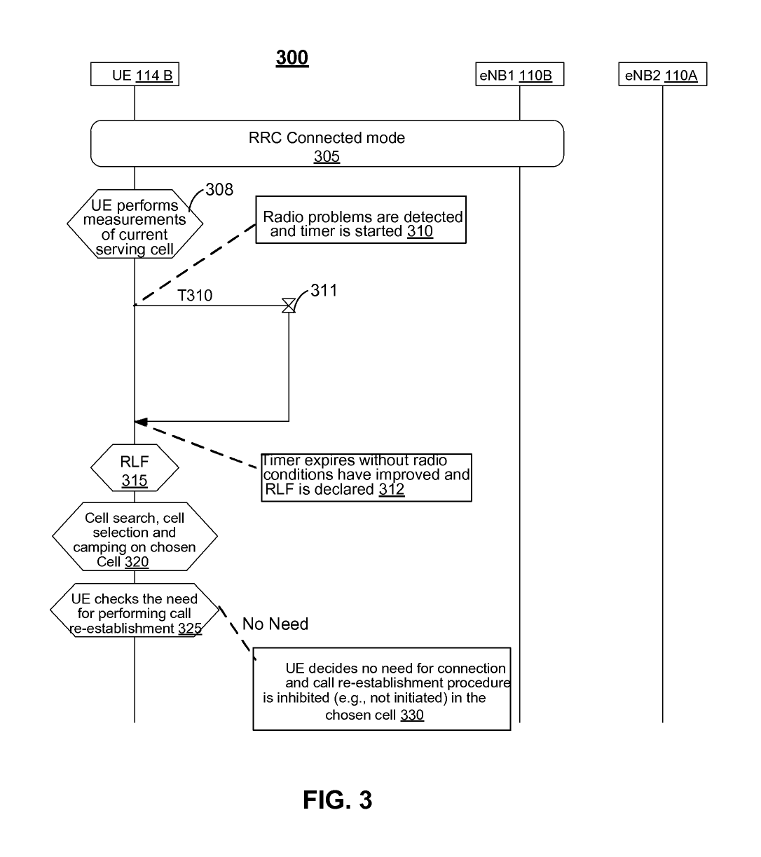

FIG. 3 depicts another example of a process 300 in which the RRC connection/reestablishment process is inhibited after a failure, in accordance with some example embodiments.

At 305, user equipment 114B may be in an RRC connected mode with the network, such as eNB base station 110B, in accordance with some example embodiments. The user equipment 114B may perform one or more measurements of the serving cell 112B, such as received signal strength of the downlink, and the like. Moreover, if the measurements indicate a problem and those problems persist at 311 for a certain period of time (e.g., after the expiration of a T310 at 312), a failure (e.g., a radio link failure (RLF), and the like) may be detected at 315. When this is the case, user equipment 114B may search at 320 for a target cell (e.g., another base station, such as eNB base station 110A, 110B, and the like), select the other cell, and camp on the other cell. The user equipment 114B may also check at 325 whether there is a need for the user equipment or an application therein to transmit (or receive) data or whether the only data that requires transmission is background or delay tolerant data. If there is no imminent need to transmit (or receive) data, user equipment 114B may inhibit the connection reestablishment by delaying the RRC connection reestablishment process until conditions change (e.g., active data requires transmission to the network or data is expected to be imminently received), in which case the user equipment may release the inhibition and allow the RRC connection reestablishment process to proceed.

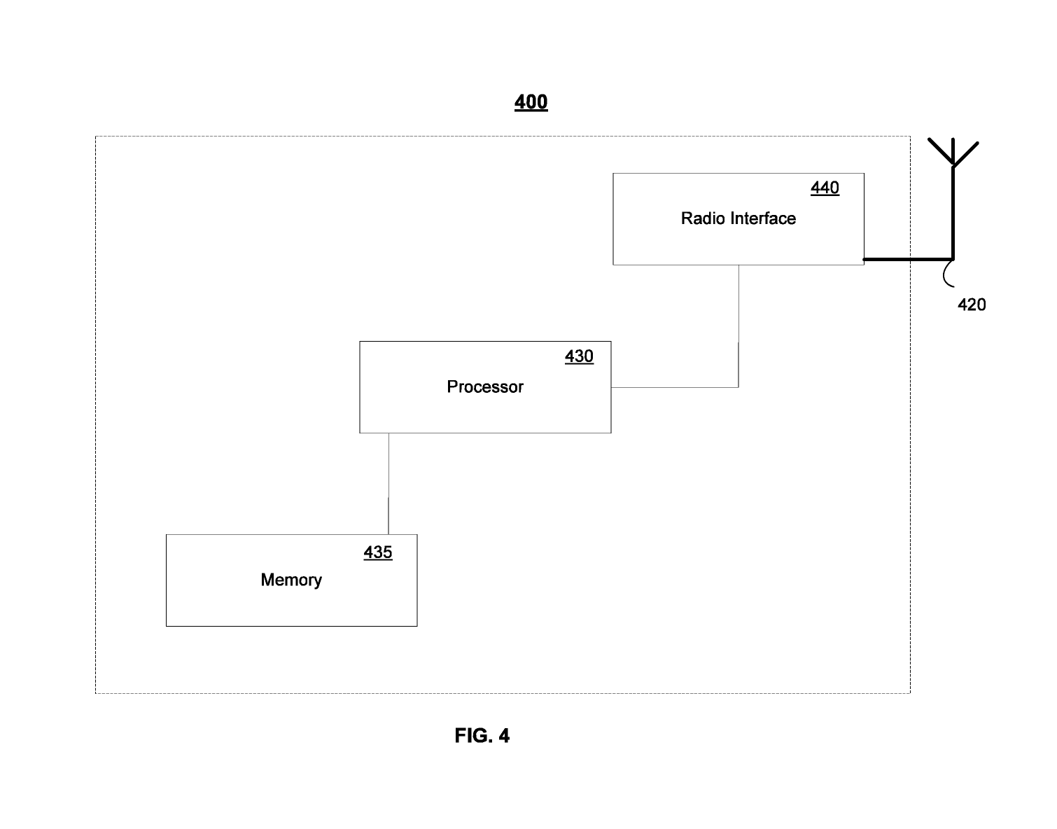

FIG. 4 depicts an example implementation of an access point 400, which may be implemented at devices 110A or 110B. The access point may include one or more antennas 420 configured to transmit via a downlink and configured to receive uplinks via the antenna(s) 420. The access point may further include a plurality of radio interfaces 440 coupled to the antenna 420. The radio interfaces may correspond to a plurality of radio access technologies including one or more of LTE, WLAN, Bluetooth, BT-LE, NFC, radio frequency identifier (RFID), ultrawideband (UWB), ZigBee, and the like. The access point may further include one or more processors, such as processor 430, for controlling the access point 400 and for accessing and executing program code stored in memory 435. In some example embodiments, the memory 435 includes code, which when executed by at least one processor causes one or more of the operations described herein with respect to an access point. The radio interface 440 may further include other components, such as filters, converters (e.g., digital-to-analog converters and the like), mappers, a Fast Fourier Transform (FFT) module, and the like, to generate symbols for a transmission via one or more downlinks and to receive symbols (e.g., via an uplink). Furthermore, the access point 400 may be configured to establish connections to the user equipment, implement a connection setup including RRC connection establishment and/or reestablishment process, generate RRC messages, send the generated messages to the user equipment, and/or perform any other operations associated with the access point (e.g., base station) disclosed herein.

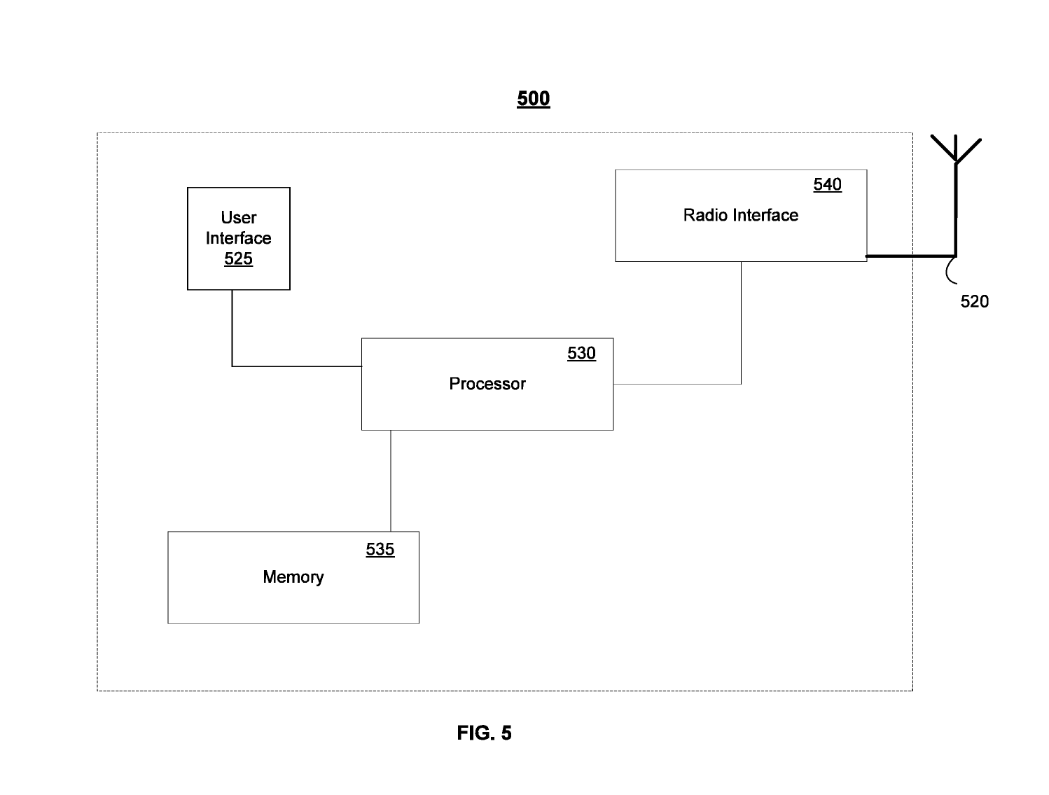

FIG. 5 depicts a block diagram of a radio, such as a user equipment 500. The user equipment 500 may include an antenna 520 for receiving a downlink and transmitting via an uplink. The user equipment 500 may also include a radio interface 540 (also referred to as a modem) coupled to the antenna 520. The radio interface 540 may correspond to a plurality of radio access technologies including one or more of LTE, WLAN, Bluetooth, BT-LE, NFC, RFID, UWB, ZigBee, and the like. The radio interface 540 may include other components, such as filters, converters (e.g., digital-to-analog converters and the like), symbol demappers, signal shaping components, an Inverse Fast Fourier Transform (IFFT) module, and the like, to process symbols, such as OFDMA symbols, carried by a downlink or an uplink. The user equipment 500 may further include a user interface 525, at least one processor, such as processor 530, for controlling user equipment 500 and for accessing and executing program code stored in memory 535. In some example embodiments, the memory 535 includes code, which when executed by at least one processor causes one or more of the operations described herein with respect to user equipment, process 200, process 300, and the like. For example, the user equipment may control the establishment and reestablishment of links to and from the base station, inhibit the establishment of those link after a failure as disclosed herein, monitor the state of traffic to or from the user equipment to determine whether to inhibit, generate RRC messages, send the generated messages to the base station, and/or perform any other operations associated with the user equipment disclosed herein.

The subject matter described herein may be embodied in systems, apparatus, methods, and/or articles depending on the desired configuration. For example, the base stations and user equipment (or one or more components therein) and/or the processes described herein can be implemented using one or more of the following: a processor executing program code, an application-specific integrated circuit (ASIC), a digital signal processor (DSP), an embedded processor, a field programmable gate array (FPGA), and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, applications, components, program code, or code) include machine instructions for a programmable processor, and may be implemented in a high-level procedural and/or object-oriented programming language, and/or in assembly/machine language. As used herein, the term “machine-readable medium” refers to any computer program product, computer-readable medium, computer-readable storage medium, apparatus and/or device (e.g., magnetic discs, optical disks, memory, Programmable Logic Devices (PLDs)) used to provide machine instructions and/or data to a programmable processor, including a machine-readable medium that receives machine instructions. Similarly, systems are also described herein that may include a processor and a memory coupled to the processor. The memory may include one or more programs that cause the processor to perform one or more of the operations described herein.

Although a few variations have been described in detail above, other modifications or additions are possible. In particular, further features and/or variations may be provided in addition to those set forth herein. Moreover, the implementations described above may be directed to various combinations and subcombinations of the disclosed features and/or combinations and subcombinations of several further features disclosed above. In addition, the logic flow depicted in the accompanying figures and/or described herein does not require the particular order shown, or sequential order, to achieve desirable results. Other embodiments may be within the scope of the following claims.

1-20. (canceled)

21. A method comprising:
disconnecting, at a user equipment, a first radio resource control connection due to a failure; and
determining, based on a state of at least one of the user equipment or an application included at the user equipment, whether to inhibit, after the failure, a connection setup by the user equipment.

22. The method of claim 21, wherein the connection setup is inhibited after the failure, when the state represents at least one of the following: a lack of active data requiring imminent transmission to a network; a presence of at least one of a delay tolerant traffic and a background traffic awaiting transmission; a long discontinuous receive cycle characterized by the lack of the active data; a timeout period expiry representing no use of at least one of the user equipment and the application; and a preference for power savings at the user equipment.

23. The method of claim 21, wherein when the state represents the active data requiring imminent transmission to the network, the connection setup proceeds by at least one of a reestablishing or an establishing of a second radio resource control connection.

24. The method of claim 21, wherein the connection setup comprises at least one of a connection reestablishment procedure and a connection establishment procedure.

25. The method of claim 24 further comprising:
selecting between the connection reestablishment procedure and the connection establishment procedure based on at least one of an expiration of a timer and a predetermined configuration defining the selecting.

26. The method of claim 25, wherein the expiration of the timer is configured by at least one of an access node, a predetermined value, or another timer operating at the user equipment.

27. The method of claim 21 further comprising:
receiving, at the user equipment, information configuring the inhibition of the connection setup.

28. The method of claim 21, wherein the failure comprises at least one of a radio link failure and a handover failure.

29. An apparatus comprising:
at least one processor; and
at least one memory including computer program code for one or more programs, the at least one processor, the at least one memory, and the computer program code configured to cause the apparatus to at least:
disconnect a first radio resource control connection due to a failure; and
determine, based on a state of at least one of the apparatus or an application included at the apparatus, whether to inhibit, after the failure, a connection setup by the apparatus.

30. The apparatus of claim 29, wherein the connection setup is inhibited after the failure, when the state represents at least one of the following: a lack of active data requiring imminent transmission to a network; a presence of at least one of a delay tolerant traffic and a background traffic awaiting transmission; a long discontinuous receive cycle characterized by the lack of the active data; a timeout period expiry representing no use of at least one of the apparatus and the application; and a preference for power savings at the apparatus.

31. The apparatus of claim 30, wherein when the state represents the active data requiring imminent transmission to the network, the connection setup proceeds by at least one of a reestablishing or an establishing of a second radio resource control connection.

32. The apparatus of claim 29, wherein the connection setup comprises at least one of a connection reestablishment procedure and a connection establishment procedure.

33. The apparatus of claim 32, wherein the apparatus is further caused to:
select between the connection reestablishment procedure and the connection establishment procedure based on at least one of an expiration of a timer and a predetermined configuration defining the selecting.

34. The apparatus of claim 33, wherein the expiration of the timer is configured by at least one of an access node, a predetermined value, or another timer operating at the user equipment.

35. The apparatus of claim 39, wherein the apparatus is further caused to:
receive information configuring the inhibition of the connection setup.

36. The apparatus of claim 39, wherein the failure comprises at least one of a radio link failure and a handover failure.

37. A non-transitory computer-readable medium encoded with instructions that, when executed by a processor, perform at least the following:
disconnecting, at a user equipment, a first radio resource control connection due to a failure; and
determining, based on a state of at least one of the user equipment or an application included at the user equipment, whether to inhibit, after the failure, a connection setup by the user equipment.

38. The computer-readable medium of claim 37, wherein the connection setup is inhibited after the failure, when the state represents at least one of the following: a lack of active data requiring imminent transmission to a network; a presence of at least one of a delay tolerant traffic and a background traffic awaiting transmission; a long discontinuous receive cycle characterized by the lack of the active data; a timeout period expiry representing no use of at least one of the user equipment and the application; and a preference for power savings at the user equipment.

39. The computer-readable medium of claim 37, wherein when the state represents the active data requiring imminent transmission to the network, the connection setup proceeds by at least one of a reestablishing or an establishing of a second radio resource control connection.

40. The computer-readable medium of claim 37, wherein the connection setup comprises at least one of a connection reestablishment procedure and a connection establishment procedure.
